(19) United States
(12) Patent Application Publication
(10) Pub. No.: US 2003/0113159 A1
(43) Pub. Date: Jun. 19, 2003

(54) Quick fastening safety device for fixing a tool to the end of a loader arm or the like

(76) Inventor: Alain Husson, Orleans (FR)

Correspondence Address: GREENBLUM & BERNSTEIN, P.L.C., 1950 ROLAND CLARKE PLACE, RESTON, VA, 20191, US

(21) Appl. No.: 10/275,260

(22) PCT Filed: May 14, 2001
(86) PCT No.: PCT/FR01/01443

(30) Foreign Application Priority Data
May 31, 2000 (FR) 00/06972

(51) Int. Cl. B25G 3/18

(52) U.S. Cl. 403/322.1

(57) ABSTRACT

The invention concerns a quick fastening safety device of the type comprising two parts (1 and 2), one of which includes a cradle (4) capable of being mounted astride a shaft (3) secured to the other part, one of the parts including an opening (7) adapted to be run through by a hook-shaped extension (6), secured to the other part, beneath which can be inserted a locking plate (8) under the action of springs which can be released, the release of said springs being brought about by passing said extension through said opening. The invention is characterized in that the hook has means adapted to counter the reverse displacement of the part comprising said hook when the latter has passed through said opening. The hook (6) has, at least, a lateral finger (11) capable of extending above the locking plate (8).

The present invention relates to a quick fastening safety device adapted for fixing a tool to the end of a loader arm or the like.

The state of the art is constituted, among other things, by the fastening described in the published French Patent Application No. 2785952.

In this document, a fastening in two parts is described, comprising a fastening member provided with a cradle allowing to straddle a shaft that is affixed to the other part, one of the parts comprising an opening that can be traversed by a hooked-shaped extension under which a slidable locking plate can be inserted, allowing to maintain one pressed against the other, both elements constituting the fastening.

The locking plate is maintained in a loaded position, and in this position, it does not oppose the passage of the hook-shaped extension through the aforementioned opening. It is during this passage that the aforementioned extension releases the locking plate that, under the action of springs that are released, is inserted under the hook in order to lock the two fastening parts together.

The hook and the plate have oblique surfaces that cooperate and press the two fastening parts together.

If, for any reason, such as the presence of dirt, for example, the locking plate does not extend completely under the corresponding portion of the hook, the aforementioned cooperation is incomplete, and under impacts and vibrations, one can fear a risk of unhooking along with all of the drawbacks that that can have.

The present invention, which overcomes this drawback, is characterized in that the hook has a means that is capable of cooperating with the locking plate to oppose the rotation of the fastening part comprising said hook.

The present invention will be better understood from the following description, with reference to the attached drawings that are given only by way of example, and in which:

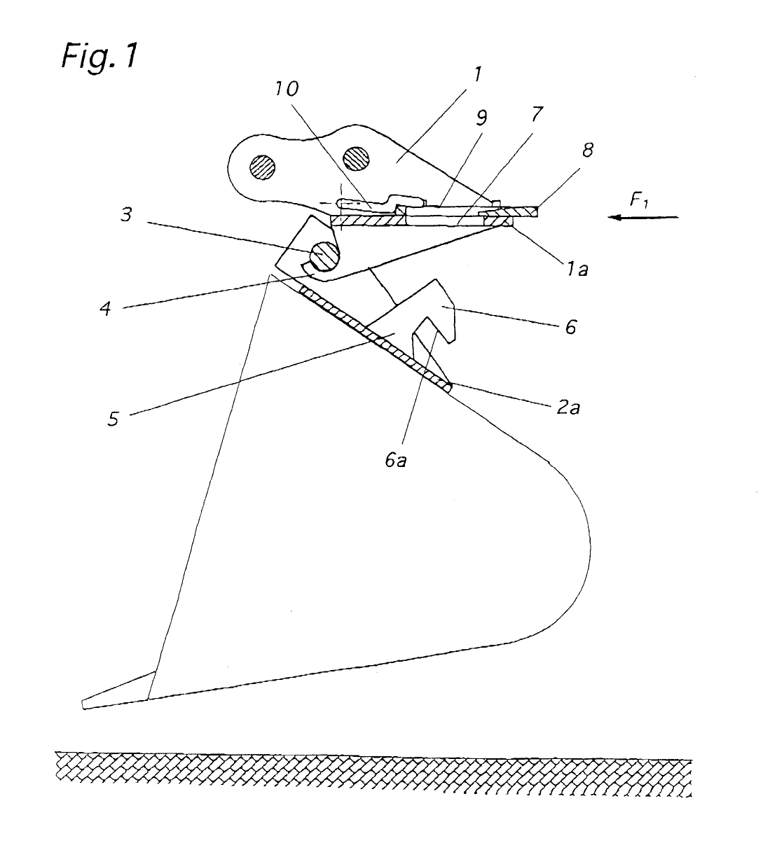

FIG. 1 is a view of a quick fastening of a known type,

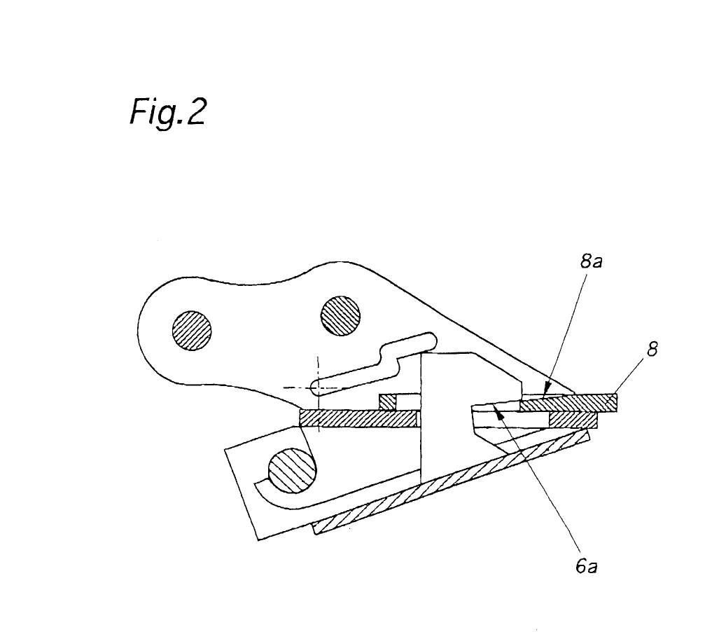

FIG. 2 is a view, on a larger scale than FIG. 1, showing the position of the locking plate when an incident occurs,

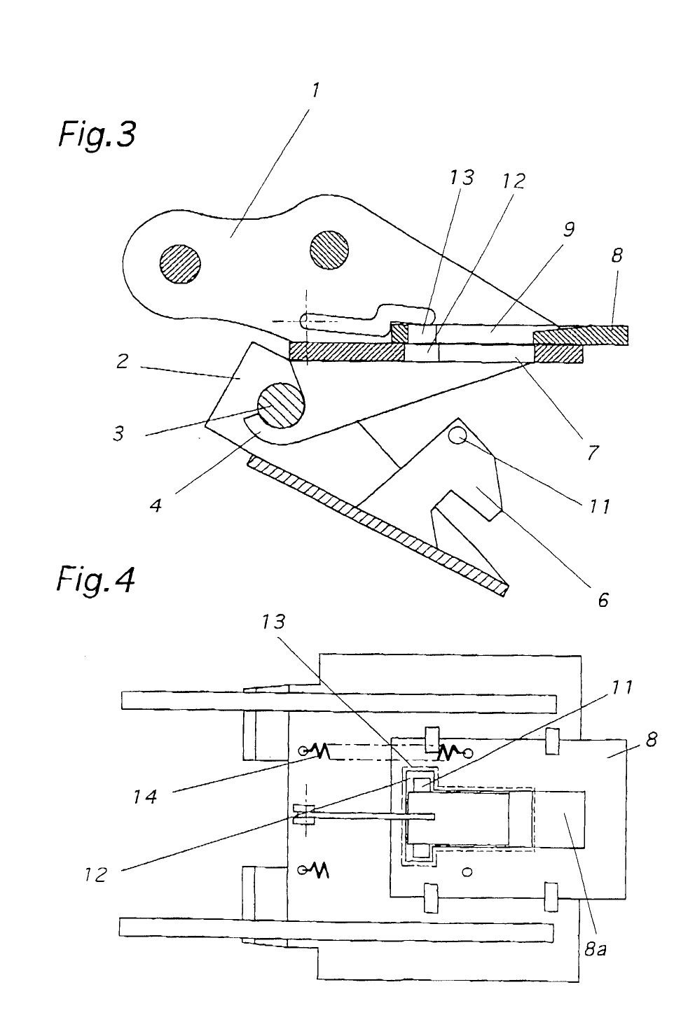

FIG. 3 is a view similar to FIG. 1, showing a modified fastening according to the invention,

FIG. 4 is the top view of FIG. 3,

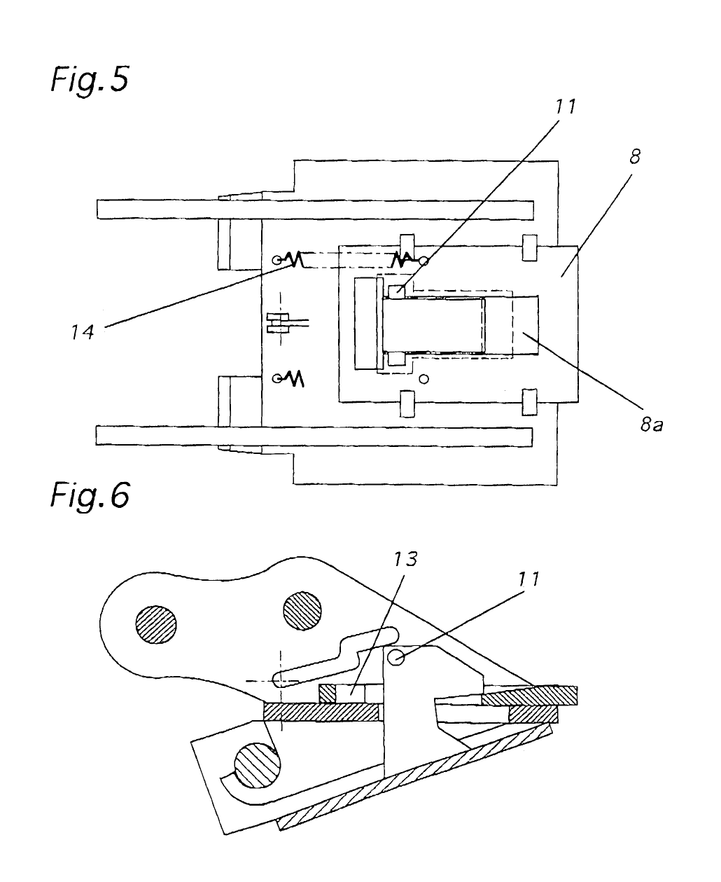

FIG. 5 is a view, similar to FIG. 4, showing the fastening in a safety position,

FIG. 6 is the front view of FIG. 5.

In referring to FIG. 1, one can see that the fastening, which is consistent with the one described in the published French Patent Application No. 2785952, comprises two parts 1 and 2, both having substantially the shape of a bracket.

One of the parts comprises a shaft 3 that can be gripped by a cradle 4 from the other part.

The part 2 has on its median portion 2a an extension 5 forming a hook 6. The extension 5 can pass through an opening 7 provided on the median portion 1a of the part 1.

A locking plate 8, having an opening 9 for the passage of the extension 5, can slide on the part 1.

In FIG. 1, the plate 8 is represented in the loaded position, the openings 7 and 9 being substantially aligned. The plate 8 is maintained in this position, for example, by means of a pivoting locking finger 10.

During rotation about the axis of the shaft 3, the extension 5 pushes back the finger 10, and the plate is displaced along the arrow F1 under the effect of common return springs.

If nothing opposes the displacement, for example, the presence of dirt, the oblique edge 8a of the plate 8 is inserted under the portion 6a of the hook, the cooperation of the oblique portions in contact having the effect of pressing the two parts of the fastening together.

If the surfaces that are to cooperate are more or less embedded in the dirt, the plate 8, under the action of the springs, which are then substantially stretched, will move along the arrow F1 but will not be completely inserted under the hook, giving the illusion of a locking which in fact did not occur. It is this type of incident that is represented in FIG. 2.

In this Figure, one notes that the surfaces 8a and 6a are not applied together. As a result, when working, the impacts and vibrations can cause the unhooking and dropping of the tool connected to the arm of the apparatus.

The present invention, which overcomes this drawback, consists of providing a safety device that opposes the pivoting of the part comprising the hook as soon as it has passed through the openings 7 and 9.

According to one embodiment, the extension 5 has, at its upper portion, at least one lateral finger 11, the openings 7 and 9 having recesses 12 and 13 allowing the passage of said finger.

When the plate 8 is in the loaded position, the common return springs 14 being stretched, the recesses 12 and 13 are aligned (FIGS. 3 and 4).

At the end of the movement, in order to go from the position shown in FIG. 4 to the one shown in FIG. 6, the extension 5 pushes back the finger 10, and the fingers 11 are located above the plane of the plate 8, which is displaced along the arrow F1.

The same type of incident shown in FIG. 2 is shown in FIG. 6: the contact between the surfaces 6a and 8a is very imperfect, for example, dirt preventing the plate 8 from being inserted completely under the hook.

If the contact between the two aforementioned surfaces is broken, the part 2 of the fastening will pivot slightly until the fingers 11 take support against the plate 8 by opposing the unhooking and dropping of the tool connected to said part 2.

1. Safety device for quick fastening of the type comprising two parts (1 and 2), one of which comprises a cradle (4) capable of straddling a shaft (3) affixed to the other part, one of the parts comprising an opening (7) that can be traversed by a hooked-shaped extension (6) that is affixed to the other part, under which a locking plate (8) can be inserted, under the action of springs that are released, the release of said springs being caused by the passage of said extension through the aforementioned opening, characterized in that the hook has a means capable of opposing the reverse displacement of the part comprising said hook as soon as the latter has passed through the aforementioned opening.

2. Device according to claim 1, characterized in that the hook (6) has at least one lateral finger (11) capable of extending above the locking plate (8).

3. Device according to claim 2, characterized in that the openings (9 and 7), provided on the locking plate (8) and on the fastening part comprising said plate, have recesses that are aligned once said locking plate is in the loaded position.
